(19) United States
(12) Patent Application Publication
(10) Pub. No.: US 2024/0091871 A1
(43) Pub. Date: Mar. 21, 2024

(54) ELECTRIC DISCHARGE MACHINING WIRE

(71) Applicant: Proterial, Ltd., Tokyo (JP)

(72) Inventors: Yosuke SHIBA, Tokyo (JP); Hiroyoshi HIRUTA, Tokyo (JP); Hiromitsu KURODA, Tokyo (JP); Shingo AMEMIYA, Tokyo (JP)

(21) Appl. No.: 18/347,069

(22) Filed: Jul. 5, 2023

(30) Foreign Application Priority Data
Sep. 9, 2022 (JP) 2022-143509

(51) Int. Cl. B23H 1/06

(52) U.S. Cl. CPC B23H 1/06

(57) ABSTRACT

An electric discharge machining wire includes a core material composed of brass with zinc concentration of more than 40 mass %, and a coating layer provided around the core material. The zinc concentration of the coating layer is higher than the zinc concentration of the core material.

### CROSS-REFERENCE TO RELATED APPLICATIONS

The present patent application claims the priority of Japanese patent application No. 2022-143509 filed on Sep. 9, 2022, and the entire contents thereof are hereby incorporated by reference.

### TECHNICAL FIELD

The present invention relates to an electric discharge machining wire (EDM wire), i.e., an electrode wire for wire electric discharge machining wire.

### BACKGROUND OF THE INVENTION

A conventionally known electric discharge machining wire has a core material made of copper or copper alloy, wherein an outer periphery is coated by a coating layer that contains zinc (see e.g., Patent Literature 1). The more electric discharge is likely to be generated with zinc than with copper due to their work functions. Therefore, in general, using an electric discharge machining wire that has a core material wherein an outer periphery is coated by a coating layer containing zinc, makes the machining speed of wire electric discharge machining faster than using an electric discharge machining wire that is consisted of a core material only.
Citation List Patent Literature 1: JP2018-99773A

### SUMMARY OF THE INVENTION

In wire electric discharge machining, an electric discharge machining wire is consumed by electric discharge, therefore, in order to avoid wire breakage (disconnection), an electric discharge machining wire should be moved constantly, so that electric discharge is generated always at a new part (i.e., a different part) of the electrode wire.

However, when a thickness of a workpiece under machining (i.e., machining object) is large, the wire breakage could be avoided while moving an electric discharge machining wire, but a coating layer that contains zinc could be lost by electric discharge while machining the workpiece. In this case, a part of the workpiece is machined by electric discharge generated between the workpiece and an exposed wire material, as a result, the machining speed of the workpiece is reduced.

The object of the invention is to provide an electric discharge machining wire including a zinc-containing coating layer around a core material, which can suppress the machining speed from slowing down, even when a part of the coating layer is lost due to electric discharge during the wire electric discharge machining.

For the purpose of solving the aforementioned problem, one aspect of the present invention provides an electric discharge machining wire, comprising a core material composed of brass with zinc concentration of more than 40 mass %; and a coating layer provided around the core material, wherein zinc concentration of the coating layer is higher than the zinc concentration of the core material.

### Advantageous Effects of the Invention

According to the present invention, it is possible to provide an electric discharge machining wire including a zinc-containing coating layer around a core material, which can suppress the machining speed from slowing down, even when a part of the coating layer is lost due to electric discharge during the wire electric discharge machining.

### BRIEF DESCRIPTION OF DRAWINGS

FIG. 1 is a cross-sectional view in a radial direction of an electric discharge machining wire according to an embodiment of the present invention.

FIG. 2A is a schematic diagram showing a machining process of a flat plate-like workpiece by wire electric discharge machining. FIG. 2B is a schematic diagram enlarging a machining part area of the workpiece.

FIG. 3 is a SEM image of a cross-section in a radial direction of a base material in the Example of the present invention.

FIG. 4A is a SEM image of a surface of the electric discharge machining wire in the Example of the present invention.

FIG. 4B is a SEM image of a cross-section in a radial direction of the electric discharge machining wire in the Example of the present invention.

FIG. 5 is a perspective view of a cuboid sample piece that is cut out for discharge machining evaluation.

### DETAILED DESCRIPTION OF THE INVENTION

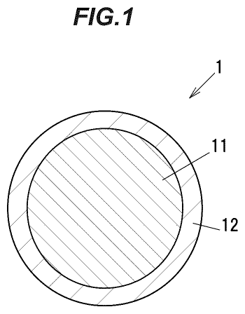

Configuration of an Electrode Wire for Wire Electric Discharge Machining FIG. 1 is a cross-sectional view in a radial direction of an electric discharge machining wire 1 (i.e., wire electric discharge machining-adapted electrode wire 1) according to the embodiment of the present invention. The wire electric discharge machining-adapted electrode wire 1 includes a core material 11 composed of brass with zinc (Zn) concentration of more than 40 mass %, and a coating layer 12 provided around the core material 11, in which zinc concentration of the coating layer 12 is higher than the zinc concentration of the core material 11.

The core material 11 is a metal wire composed of brass with zinc (Zn) concentration of more than 40 mass %, i.e., an alloy consisting essentially of zinc with a concentration of more than 40 mass %, and the balance being copper and inevitable impurities. The zinc concentration of the core material 11 is higher than the zinc concentration of a core material of a conventional electric discharge machining wire. Because more electric discharge can be generated with zinc than with copper due to their work functions, the core material 11 may have more electric discharge with a workpiece than the conventional electric discharge machining wire during wire electric discharge machining.

On the other hand, the more zinc concentration of the core material 11 is, the more difficult for the core material 11 to maintain its strength, thus, machining would be difficult. For that reason, the zinc concentration of the core material 11 is, e.g., set to 43 mass % or less. The inventors of the present application have confirmed that the core material 11 with a wire diameter of 0.1 mm or more can be manufactured when the zinc concentration of the core material 11 is set to 43 mass %. Additionally, the core material 11 with a wire diameter of less than 0.1 mm could be manufactured, but it is considered that the machining would be more difficult because of the low strength of the smaller wire diameter.

The coating layer 12 is a layer made of a zinc film as a base material and includes copper (Cu). The coating layer 12 is, e.g., manufactured by providing a Zn-plating on a surface of the core material 11, and copper is diffused from the core material 11 into the coating layer 12 in the manufacturing process of the wire electric discharge machining-adapted electrode wire 1. In this manner, when copper is diffused into a pure zinc layer while the coating layer 12 is being formed, the zinc concentration of the surface of the coating layer 12 becomes, e.g., 80 mass % or more.

Also, in the manufacturing process of the wire electric discharge machining-adapted electrode wire 1, when heat treatment is performed after wire drawing process, the zinc concentration of the surface of the coating layer 12 becomes higher than the zinc concentration inside the coating layer 12. The zinc concentration inside the coating layer 12 is, e.g., 60 mass % or more, and the zinc concentration of the surface of the coating layer 12 is, e.g., 80 mass % or more. With the coating layer 12 of the above zinc concentrations, the machining speed can be prevented from slowing down more easily.

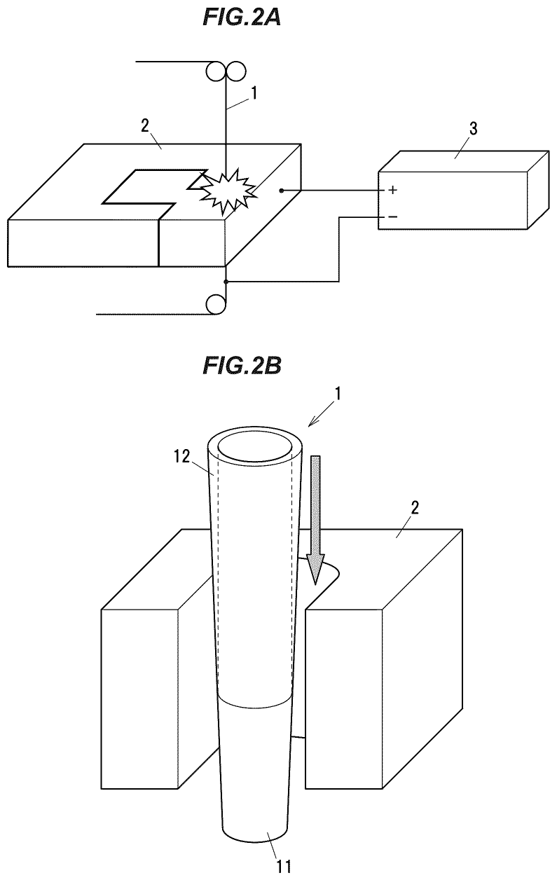

FIG. 2A is a schematic diagram showing the machining process of a flat plate-like workpiece 2 by the wire electric discharge machining. In the wire electric discharge machining, as shown in FIG. 2A, a pulse voltage is applied by a machining power supply 3 between the wire electric discharge machining-adapted electrode wire 1 and the workpiece 2 made of metallic materials such as SKD-11 (according to JIS Standard). While electric discharge is generated between the wire electric discharge machining-adapted electrode wire 1 and the workpiece 2 made of metallic materials, the wire electric discharge machining-adapted electrode wire 1 is sent and moved like a coping saw with respect to the workpiece 2, and a two-dimensional machining is performed on the workpiece 2 to provide a pre-programmed shape.

FIG. 2B is a schematic diagram enlarging the machining part area of the workpiece 2. When the thickness of the workpiece 2 is large, as shown in FIG. 2B, a part of the coating layer 12 may be lost while machining the workpiece 2 due to the electric discharge. The thickness of the workpiece 2 is a vertical dimension of the workpiece 2 in FIGS. 2A and 2B.

In the example shown in FIG. 2B, the wire electric discharge machining-adapted electrode wire 1 is moved downward during the machining, a part of the coating layer 12 where the electric discharge has started is lost before passing the bottom of the workpiece 2, therefore, a lower part of the workpiece 2 is machined by the electric discharge generated between the exposed core material 11 and the workpiece 2.

Because the zinc concentration of the core material 11 is lower than that of the coating layer 12, it is more difficult to generate the electric discharge between the workpiece 2 and the core material 11 than between the workpiece 2 and the coating layer 12. However, as mentioned above, because the core material 11 has a higher zinc concentration than a conventional core material, even when the coating layer 12 is lost and electric discharge is generated between the exposed core material 11 and the workpiece 2, the reduction of the electric discharge can be suppressed, and thus, the machining speed of the workpiece 2 can be suppressed from slowing down.

The wire diameter of the wire electric discharge machining-adapted electrode wire 1 is, e.g., 0.1 mm or more and 0.4 mm or less, and the thickness of the coating layer 12 is, e.g., 1.0 μm or more and 5.0 μm or less. Additionally, the wire electric discharge machining-adapted electrode wire 1 has the tensile strength (TS) of 750 MPa or more and 1500 MPa or less, the elongation (EL) of 0.4% or more and 5.0% or less, and the electrical conductivity of 20% or more and 30% or less.

Here, the tensile strength (TS) of the wire electric discharge machining-adapted electrode wire 1 is a value measured by using a tensile compression tester SV-301-E-L manufactured by IMADA SEISAKUSHO CO., LTD. as a measuring device, and by taking the following steps:
(1) First, prepare the wire electric discharge machining-adapted electrode wire 1 with a predetermined length as a sample.
(2) Fix both ends of the sample to the above-mentioned measuring device and keep the sample in a straight line.
(3) In that state, pull one end of the sample by a constant speed of 50 mm/min.
(4) Measure the maximum load (load range: 100N) when the sample is broken.
(5) Divide a breaking load value by a cross-sectional area of the sample to calculate the tensile strength.

Additionally, a measurement of the elongation (EL) of the wire electric discharge machining-adapted electrode wire 1 was performed using the same tester as the one used for the aforementioned tensile strength (TS) measurement, as well as taking the same steps (1) to (3). A gauge length was measured when the sample was broken, then the elongation was calculated by an equation “EL=100×(L−L₀)/L₀.” Here, “L” stands for the gauge length when the sample was broken, and “L₀” stands for the gauge length before the sample was pulled.

Also, the electrical conductivity of the wire electric discharge machining-adapted electrode wire 1 is a value measured by a method that complies with JIS H 0505. Here, 8.89 was used as a specific gravity to calculate the electrical conductivity.

### Manufacturing Method of the Wire Electric Discharge Machining-Adapted Electrode Wire

As an example of manufacturing the wire electric discharge machining-adapted electrode wire 1, below is a manufacturing method of the wire electric discharge machining-adapted electrode wire 1 with a wire diameter of 0.3 mm.

First, a base material with a wire diameter of 0.6 to 1.2 mm before a wire drawing process of the wire electric discharge machining-adapted electrode wire 1 is prepared. The coating layer of the base material is, e.g., a zinc film formed by Zn-plating on the surface of a brass wire which is a core material. The base material in a necessary amount, e.g., 50 kg is prepared.

Next, after passing property investigations and visual and cross-section inspections, the base material is passed through wire drawing dies installed on a wire drawing machine, and the wire drawing process, e.g., at a speed of about 700 m/min is performed, so that the wire diameter becomes 0.3 mm. The base material after the drawing process is called a drawn wire material.

After that, the heat treatment is performed on the drawn wire material using a furnace to obtain the wire electric discharge machining-adapted electrode wire 1. It is preferable to perform the heat treatment so that zinc powder generation from the coating layer 12 can be suppressed when using the wire electric discharge machining-adapted electrode wire 1. Because pure zinc is brittle and crumbles into powder, the heat treatment is performed to diffuse copper from the core material 11 into the coating layer 12 so that the zinc powder generation from the coating layer 12 can be suppressed.

The conditions of the heat treatment are, e.g., for 1.5 hours at 150° C., but the temperature can be set lower in order to improve the straightness of the wire electric discharge machining-adapted electrode wire 1. Concretely speaking, the heat treatment conditions can be set, e.g., to a temperature of more than 100° C. and 170° C. or less, and for a duration of one hour or longer.

Evaluation of the Wire Electric Discharge Machining-Adapted Electrode Wire As Example of the wire electric discharge machining-adapted electrode wire 1 according to the present invention, an electrode wire composed of the core material 11 made of brass with the zinc concentration of 43 mass % (Cu:Zn=7:43) and the coating layer 12 provided on the surface of the core material 11, and the wire diameter of about 0.3 mm, was manufactured and evaluated.

First, the base material of the wire electric discharge machining-adapted electrode wire 1 in the Example was prepared and inspections were performed. Here, the base material was composed of the core material composed of brass with zinc concentration of 43 mass %, the wire diameter of 0.9 mm, and the coating layer of 8±2 μm Zn-plating.

The base material was visually observed by microscope and SEM and it was confirmed that there was no extraordinary damage or falloff of the Zn-plating.

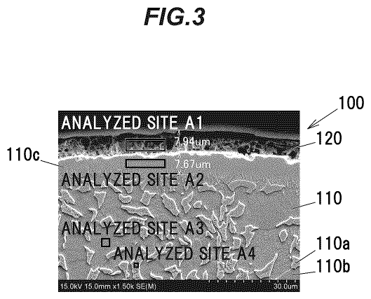

FIG. 3 is a SEM image of the cross-sectional view in the radial direction of the base material 100 in the Example. Etching was performed on the cross-sectional surface of the base material 100 in order to observe its metal texture. A convex part 110a and a concave part 110b on the cross-section of the core material 110, which were made visible by the etching, are an α phase of brass and a β phase of brass respectively.

Table 1 below shows the results of EDX elemental analysis on Analyzed Sites A1 to A4 and a surface of a coating layer 120 (Analyzed Site A0) on the cross-section shown in FIG. 3. “CuK” and “ZnK” in Table 1 are respectively a copper concentration and a zinc concentration analyzed using K-line as characteristic X-ray. Also, “mass %” and “at %” in Table 1 are mass percent and atomic percent respectively.

TABLE 1

| | Analyzed Site | | Analyzed Site | | Analyzed Site | | Analyzed Site | | Analyzed Site | |
|---|---|---|---|---|---|---|---|---|---|---|
| | A0 | | A | | A2 | | A3 | | A4 | |
| Element | mass % | at % | mass % | at % | mass % | at % | mass % | at % | mass % | at % |
| CuK | 1.26 | 1.29 | 3.54 | 3.64 | 56.75 | 57.45 | 55.79 | 56.49 | 62.07 | 62.74 |
| ZnK | 98.74 | 98.71 | 96.46 | 96.36 | 43.25 | 42.55 | 44.21 | 43.51 | 37.93 | 37.26 |

The results of elemental analysis of the Analyzed Site A0 and the Analyzed Site A1 show that the coating layer 120, that is, a Zn-plating film was formed without any problems. The results of the Analyzed Site A3 and the Analyzed Site A4 respectively show 0-phase element concentrations and a-phase element concentrations of the core material 110.

Additionally, on the surface of the core material 110, a layer 110c which was not separated into the α-phase and β-phase can be seen in FIG. 3. The element composition of the layer 110c is not clear, but according to the analysis results of the Analyzed Site A2, it may be composed of the β-phase. Also, it is possible that the layer 110c was generated by the wire drawing of the core material 110 or the Zn-plating process.

Table 2 below shows the target values and evaluation results of mechanical characteristics of the base material 100 in the Example. “Wire diameter,” “coating layer thickness,” “tensile strength,” “elongation,” and “electrical conductivity” in Table 2 are respectively a wire diameter of the base material 100, a thickness of the coating layer 120, a tensile strength (TS) of the base material 100, elongation (EL) of the base material 100, and electrical conductivity of the base material 100. Also, the tensile strength, elongation, and electrical conductivity in Table 2 were all measured by the aforementioned methods. The evaluations of mechanical characteristics were performed on three samples of the base material 100.

TABLE 2

| | | Coating | | | |
|---|---|---|---|---|---|
| | Wire | Layer | Tensile | | Electrical |
| | Diameter | Thickness | Strength | Elongation | Conductivity |
| | (mm) | (μm) | (MPa) | (%) | (%) |
| Target Value | 0.902-0.930 | 6-10 | 450 or more | 18 or more | — |
| Measured | 0.911 | 9.9 | 585.3 | 25.0 | 32.1 |
| Values of | 0.911 | | 583.6 | 22.8 | 32.1 |
| Examples | 0.911 | | 587.0 | 24.2 | 32.2 |

As Table 2 shows, it was confirmed that the tensile strength, elongation, and electrical conductivity of the base material 100 in the Example all met the target values.

Next, the wire drawing process was performed on the base material 100, then when its wire diameter became 0.3 mm, the heat treatment was performed on the drawn wire material thus obtained at 150° C. for 1.5 hours, and the wire electric discharge machining-adapted electrode wire 1 was manufactured.

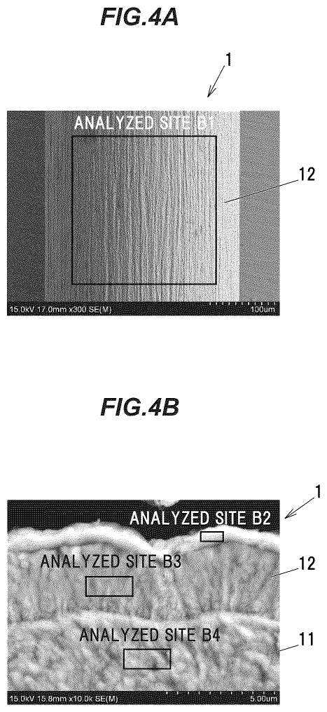

FIGS. 4A and 4B are respectively an SEM image of the surface and an SEM image of a cross-section in the radial direction of the wire electric discharge machining-adapted electrode wire 1 in the Example. FIG. 4A shows that there was no crack on the surface of the coating layer 12, i.e., the coating layer 12 has a crack-free 1. Additionally, it was confirmed that when the wire drawing process was performed after the heat treatment, cracks were formed on the surface of the coating layer 12. In manufacturing the wire electric discharge machining-adapted electrode wire 1 in the Example, it is assumed that the crack formation on the surface was prevented since the heat treatment was performed after the wire drawing process.

Table 3 below shows the results of the EDX elemental analysis of Analyzed Site B1 on the surface of the coating layer 12 in FIG. 4A, and those of the surface of the coating layer of the drawn wire material which is the wire electric discharge machining-adapted electrode wire 1 before the heat treatment. In Table 3, the element concentrations of the surface of the coating layer of the drawn wire material are marked “before heat treatment.”

TABLE 3

| | Analyzed Site B1 | | Before Heat Treatment | |
|---|---|---|---|---|
| Element | mass % | at % | mass % | at % |
| CuK | 18.78 | 19.22 | 3.71 | 3.81 |
| ZnK | 81.22 | 80.78 | 96.29 | 96.19 |

From the results of the elemental analysis in Table 3, it was confirmed that copper diffusion into the coating layer 12 was caused by the heat treatment.

Table 4 below shows the results of the EDX elemental analysis on Analyzed Sites B2, B3, and B4 of the cross-section of the wire electric discharge machining-adapted electrode wire 1 in FIG. 4B.

TABLE 4

| | Analyzed Site B2 | | Analyzed Site B3 | | Analyzed Site B4 | |
|---|---|---|---|---|---|---|
| Element | mass % | at % | mass % | at % | mass % | at % |
| CuK | 34.78 | 35.43 | 35.43 | 36.09 | 57.64 | 58.34 |
| ZnK | 65.22 | 64.57 | 64.57 | 63.91 | 42.36 | 41.66 |

Comparing the element concentrations of Analyzed Site B1 with those of Analyzed Sites B2 and B3, it was confirmed that the zinc concentration was higher on the surface of the coating layer 12 than the inner part of the coating layer 12. It is because the inner part of the coating layer 12, which is closer to the core material 11, includes more diffused copper. Also, comparing the element concentrations of Analyzed Sites B2 and B3 with those of Analyzed Site B4, the zinc concentration of the inner part of the coating layer 12 is sufficiently higher than the zinc concentration of the core material 11.

Table 5 below shows the target values and evaluation results of mechanical characteristics of the wire electric discharge machining-adapted electrode wire 1 in the Example. The “wire diameter,” “tensile strength,” “elongation,” and “electrical conductivity” in Table 5 are respectively, wire diameter of the wire electric discharge machining-adapted electrode wire 1, tensile strength (TS) of the wire electric discharge machining-adapted electrode wire 1, elongation (EL) of the wire electric discharge machining-adapted electrode wire 1, and electrical conductivity of the wire electric discharge machining-adapted electrode wire 1. Also, the tensile strength, elongation, and electrical conductivity in Table 5 were all measured by the aforementioned methods. The evaluations of the mechanical characteristics were performed on three samples of the wire electric discharge machining-adapted electrode wire 1.

TABLE 5

| | Wire | Tensile | | Electrical |
|---|---|---|---|---|
| | Diameter | Strength | Elongation | Conductivity |
| | (mm) | (MPa) | (%) | (%) |
| Target Value | 0.298-0.300 | 784 or more | 0.4 or more | — |
| Measured | 0.300 | 1019.0 | 2.1 | 24.1 |
| Value of | 0.300 | 1015.3 | 2.1 | 24.2 |
| Example | 0.300 | 1022.7 | 2.2 | 24.2 |

As Table 5 shows, the tensile strength, elongation, and electrical conductivity of the wire electric discharge machining-adapted electrode wire 1 in the Example all met the target values.

Next, an evaluation of electric discharge machining was performed using the wire electric discharge machining-adapted electrode wire 1 in the Example (hereinafter referred to as “the electrode wire in the Example”). An evaluation was also performed using an “HBZ-U (N)” wire made of brass with zinc concentration of 40 mass %, as an electric discharge machining wire in a comparative example (hereinafter referred to as “the electrode wire in the comparative example”) manufactured by Proterial, Ltd. (formerly Hitachi Metals, Ltd.)

In this evaluation of electric discharge machining, a flat plate-like sample piece 20 of 10×10 mm was cut out from a flat plate-like material made of SKD-11 as the workpiece 2 by electric discharge machining using “Robocut α-0iE” manufactured by Fanuc Corporation as a wire electric discharge machine. Also, automatic connection was able to be performed without any problem on the electrode wire in the Example by the wire electric discharge machine.

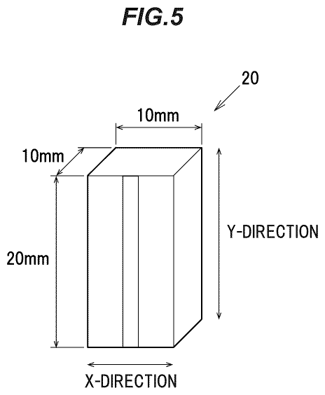

FIG. 5 is a perspective view of the sample piece 20 that was cut out as a cuboid in the evaluation of electric discharge machining. The X-direction in FIG. 5 is parallel to a flat surface of the workpiece 2, in other words, perpendicular to a wire-moving direction, and the Y-direction is parallel to the thickness of the workpiece 2, in other words, parallel to the wire-moving direction. The wire moving direction here is a direction where an electrode wire is moved toward in wire electric discharge machining by a wire electric discharge machine. The sample piece 20 in FIG. 5 was cut out from the workpiece 2 of 20 mm thick, but if it is cut out from the workpiece 2 of 50 mm thick, the thickness or Y-direction dimension is 50 mm.

Table 6 below shows the machining speeds obtained by electric discharge machining using the electrode wires in the Example and the comparative example. “Plate thickness” in Table 6 is a thickness of the workpiece 2 in flat-plate shape used for the evaluation of electric discharge machining. “1st” in Table 6 means that the machining was performed only for the first cut and the machining time was once. Also, “3rd” in Table 6 means that the machining was performed from the first to third cuts and the machining time was three. The machining speed of the “3rd” was calculated by summing up the three machining times. “Example” and “Comparative example” in Table 6 mean that electrode wires used for the machining are respectively the electrode wire in the Example and the electrode wire in the comparative example. “Ratio” in Table 6 is a machining speed ratio of a case where the electrode wire in the Example was used to a case where the electrode wire in the comparative example was used.

TABLE 6

| Plate | | | Machining | |
|---|---|---|---|---|
| Thickness | Machining | Electrode | Speed | |
| (mm) | Time | Wire | (mm/min) | Ratio |
| 20 | 1st | Example | 5.30 | 104% |
| | | Comparative | 5.08 | |
| | | Example | | |
| | 3rd | Example | 6.51 | 106% |
| | | Comparative | 6.11 | |
| | | Example | | |
| 50 | 1st | Example | 2.56 | 106% |
| | | Comparative | 2.43 | |
| | | Example | | |
| | 3rd | Example | 3.80 | 108% |
| | | Comparative | 3.52 | |
| | | Example | | |

As shown in Table 6, it was confirmed that the machining speed when using the electrode wire in the Example was higher than the machining speed when using the electrode wire in the comparative example. Also, the machining speed ratio of the Example to the comparative example was higher when the thickness of the workpiece 2 was 50 mm than when the thickness of the workpiece 2 was 20 mm. Judging from the results, it is considered that the electrode wire in the comparative example included no coating layer including zinc, and thus, the machining speed was not reduced due to the loss of the coating layer when the workpiece 2 is thick. Therefore, when using the electrode wire in the Example, even when the workpiece 2 is thick to the extent that a part of the coating layer 12 is lost, the machining speed can be maintained high. Additionally, when the machining time was three times, the machining speed ratio of the Example to the comparative example was higher than when the machining time was one time.

Table 7 below shows a shape accuracy of the sample piece 20 obtained by the electric discharge machining using the electrode wire in the Example and the electrode wire in the comparative example. In Table 7, “Top” is a width in the X-direction at the top of the sample piece 20 in the Y-direction, “Middle” is a width in the X-direction in the middle of the sample piece 20 in the Y-direction, and “Bottom” is a width in the X-direction at the bottom of the sample piece 20 in the Y-direction. Also, “R” is a difference between the minimum value and the maximum value of “Top,” “Middle,” and “Bottom,” which can be variation indexes for a width in the X-direction of the sample piece 20.

TABLE 7

| Plate | | | | | | |
|---|---|---|---|---|---|---|
| Thickness | Machining | Electrode | X-direction width of sample piece (mm) | | | |
| (mm) | Time | Wire | Top | Middle | Bottom | R |
| 20 | 1^{st} | Example | 9.986 | 9.988 | 9.993 | 0.007 |
| | | Comparative | 9.991 | 9.994 | 9.996 | 0.005 |
| | | Example | | | | |
| | 3rd | Example | 10.000 | 10.000 | 10.000 | 0.000 |
| | | Comparative | 10.001 | 10.002 | 10.002 | 0.001 |
| | | Example | | | | |
| 50 | 1st | Example | 9.987 | 9.978 | 9.988 | 0.010 |
| | | Comparative | 9.986 | 9.978 | 9.987 | 0.009 |
| | | Example | | | | |
| | 3rd | Example | 10.010 | 10.018 | 10.011 | 0.008 |
| | | Comparative | 10.010 | 10.016 | 10.010 | 0.006 |
| | | Example | | | | |

According to Table 7, the width variation in the X-direction of the sample piece 20 when using the electrode wire in the Example was, regardless of machining conditions, almost the same as that when using the electrode wire in the comparative example. Judging from the results, the shape accuracy of the sample piece 20 when using the electrode wire in the Example was almost the same as that when using the electrode wire in the comparative example.

### Effect of the Embodiment

According to the above embodiment of the present invention, using the wire electric discharge machining-adapted electrode wire 1 that is composed of the core material 11 made of brass with zinc (Zn) concentration of 40 mass % or more, and the coating layer 12 provided around the core material 11 wherein zinc concentration of the coating layer 12 is higher than the zinc concentration of the core material 11, can suppress the machining speed from slowing down even when a part of the coating layer 12 is lost due to electric discharge during the wire electric discharge machining.

### SUMMARY OF THE EMBODIMENT

Next, technical ideas understood from the above embodiment, are described with reference to the reference numerals and the like used in the embodiment. However, each reference numeral in the following description does not limit the constituent elements in the scope of claims to the members and the like specifically shown in the embodiment.

According to the first feature, an electric discharge machining wire 1 (i.e., wire electric discharge machining-adapted electrode wire 1) includes a core material 11 composed of brass with zinc (Zn) concentration of more than 40 mass %, and a coating layer 12 provided around the core material 11, wherein zinc concentration of the coating layer 12 is higher than the zinc concentration of the core material 11.

According to the second feature, in the electric discharge machining wire 1 as described in the first feature, the zinc concentration of the core material 11 is 43 mass % or less.

According to the third feature, in the electric discharge machining wire 1 as described in the first or second feature, the coating layer 12 has a first zinc concentration at a surface which is higher than a second zinc concentration at an inner part.

According to the fourth feature, in the electric discharge machining wire 1 as described in the first or second feature, the coating layer 12 has a crack-free surface.

In the above description, the embodiment of the present invention has been explained. However, the present invention is not limited to the above embodiment, and various modifications can be made without departing from the scope and spirit of the invention. Also, the embodiment does not limit the invention according to the scope of claims. Additionally, it should be noted that not all combinations of features are essential to the means for solving problems of the invention.

1. An electric discharge machining wire, comprising:
a core material composed of brass with zinc concentration of more than 40 mass %; and
a coating layer provided around the core material,
wherein zinc concentration of the coating layer is higher than the zinc concentration of the core material.

2. The electric discharge machining wire, according to claim 1, wherein the zinc concentration of the core material is 43 mass % or less.

3. The electric discharge machining wire, according to claim 1, wherein the coating layer has a first zinc concentration at a surface which is higher than a second zinc concentration at an inner part.

4. The electric discharge machining wire, according to claim 1, wherein the coating layer comprises a crack-free surface.
